(19) United States
(12) Patent Application Publication
(10) Pub. No.: US 2022/0257456 A1
(43) Pub. Date: Aug. 18, 2022

(54) Waterproof Vibrating Floating Device

(71) Applicant: Renee E Taylor, Altamonte Springs, FL (US)

(72) Inventor: Renee E Taylor, Altamonte Springs, FL (US)

(21) Appl. No.: 17/733,701

(22) Filed: Apr. 29, 2022

Related U.S. Application Data
(63) Continuation of application No. 17/512,651, filed on Oct. 27, 2021.
Application No. 17/512,651 is a continuation of application No. 63/106,359, filed on Oct. 28, 2020.

(51) Int. Cl. A61H 19/00

(52) U.S. Cl. CPC A61H 19/30; A61H 37/005

(57) ABSTRACT

This device can be categorized as a body massager or sex toy, that is designed to operate immersed in water or dry. This present invention relates to an elongated cellular foam tube presently referred to as a “noodle”, used for play or floatation support in a pool or aquatic source. The inner core of the elongated floating device will comprise of a series of vibrating motors, controlled wirelessly with variational speed and vibrational intensity. The vibrational motors will impart vibrations to the elongated floating device which in turn can transfer the vibrations to the user in contact with vibrating device for massage or sexual stimulation.

### FIELD OF INVENTION

This present invention relates to an elongated cellular foam tube presently referred as a “noodle”, used for play or floatation support in a pool or aquatic source, with an added wireless waterproof vibrating motor.

### BACKGROUND

Conventional swimming noodles are typically elongated, cylinder shape, floatation device made from deformable and floatable material for recreational use in pools, beaches, lakes or other large bodies of water. The swimming noodle are mainly used for flotation and relaxation by supporting the body weight of the user, by straddling, placing under the arms or around the neck. The noodle can also be used for exercising in water by supporting the body to avoid straining, and support while swimming.

There are massagers and waterproof vibrating sexual toys on the market, however, they are not designed to be used as a floating device immersed in water. The vibration is transmittable and felt throughout the floating device making it a great body massager, due to it's formability it can be manipulated to reach almost all parts of the body. The device can be used to provide massage to the body to relieve muscle tensions, aid in water exercises and can be used as a sexual aid. This device can be categorized as a body massager or sex toy, that is designed to operate immersed in water or dry.

The vibrating elongated floating device for massage and/or sexual stimulation will combine the relaxation of floating with the ability to achieve sexual gratification and provide muscle relaxation. This device would add a built-in waterproof, wireless vibrator with multiple speeds, making this device able to provide sexual stimulation and vibrational massages with adjustable vibrational pressure.

The use of sexual stimulation devices in aquatic environments, particularly while floating, can promote enhanced sexual experiences. Reports have suggested that flotation increases the secretion of neuro-chemicals associated with pleasure or well-being, thereby heightening sensations obtained via sexual stimulation while afloat.

Reports have also indicated that floating increases production of theta waves, which are associated with vivid memories, free association, sudden insights, creative inspiration, and feelings of serenity and oneness with the universe. Aquatic environments are thus well-suited to the appropriate use of sexual stimulation devices to produce enhanced pleasure. It is therefore an objective of the present invention to introduce an assembly that converts a standard personal elongated floating device into an aquatic massager and sexual stimulation device.

### BRIEF DESCRIPTION OF PICTURES

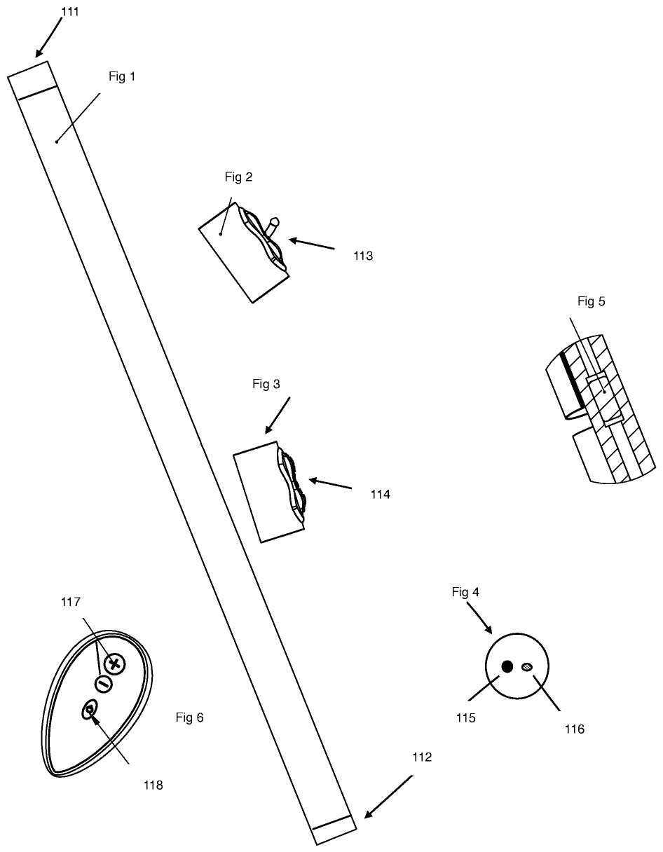

FIG. 1—External view of elongated floating device

FIG. 2—Elongated floating device attachment with phallus

FIG. 3—Elongated floating device attachment with raised ridges

FIG. 4—Top view of end cap of elongated floating device with adjustable vibrational dial and charging portal for vibrating motor

FIG. 5—Internal view of elongated floating device, to show placement of vibrating motor incased in silicone or other water resistant protective material.

FIG. 6—Wireless remote control for device with power function and adjustable vibrational speed.

### REFERENCE NUMBERS

111—End cap of elongated floating device to enclose vibrational motors
112—End cap of elongated floating device with on/off adjustable vibrational dial and waterproof charging port
113—Sideview of phallic attachment
114—Sideview of raised rigid attachment
115—Power switch and adjustable vibration control button
116—Waterproof port charger
117—Adjustable speed control on wireless remote control
118—Power switch on wireless remote control

### DETAILED DESCRIPTION

This description is intended to explain certain aspects, advantages, and novel features of various embodiments, and is not to be taken in a limiting sense, many additional embodiments of this invention are possible. It is understood that no limitation of the scope of the invention is thereby intended. It is to be understood that not necessarily all such advantages may be achieved in accordance with any particular embodiment. All illustrations of the drawings are for the purpose of describing selected versions of the present invention and are not intended to limit the scope of the present invention.

It is to be understood that the invention is not limited in its application to the details of the components and arrangements as described or illustrated. The invention is capable of other embodiments and of being utilized and carried out in various ways. It is also to be understood that the phrasing and terminology employed herein are for the purpose of description and should not be regarded as limiting.

In the preferred embodiment of the present invention depicted in FIGS. 1-6, the assembly comprises of an elongated floating device (FIG. 1) with a series of five (5) built-in waterproof vibrating motors (FIG. 5). The built-in vibrators will be placed at equal distance to ensure an even distribution of vibration throughout the elongated floating device. The elongated floating device will be operated by controls situated on the end cap of the device reference #112 (FIG. 1). The end cap will hold a nautical waterproof power switch with a dial control for variational vibrational speed and intensity, reference #115 (FIG. 4). The device will have the additional ability to be operated by wireless remote with a power switch and control buttons for vibrational speed and intensity, reference #117 and #118 (FIG. 6). The end cap will also hold a nautical waterproof port to charge the series of vibrational motors, reference #116 (FIG. 4). The device will be rechargeable by a power adapter.

For added sexual stimulation the elongated floating device will be fitted for attachments that can be used with or without the elongated floating device (FIGS. 2 and 3). The attachments will be constructed with skin safe material, silicone, plastic, rubber, material is not limited. The attachments will have additional features to enhance sexual pleasure and transform elongated floating device into a sexual aid device; reference #113 is a phallic attachment, reference #114 has raised ridges and grooves (FIGS. 2 and 3).

What is claimed is:

1. An assembly with an elongated cellular foam tube with an outer core made from a buoyant material used as a floatation support in a pool or aquatic source; within said assembly has 5 vibrational motors encased in the inner core, which is encased in the outer core. The inner core made of a pliable material; and the vibration motor configured to impart vibrations to the elongated floating device, wherein the elongated floating device is configured to transfer the vibrations to one or more body parts of a user in contact with the vibrating elongated floating device for massage, and sexual stimulation.

2. The vibrating elongated floating device wherein the cap comprises: a power button, wherein the power button in electrical communication with the vibration motor and configured to turn the vibration motor on and off; a charging port, the charging port in electrical communication with a charging circuitry, the charging circuitry configured to a charge a battery also enclosed within the outer core, the battery powers the vibration motor; and one or more control buttons in electrical communication with the vibration motor for increasing or decreasing a vibration frequency of the vibration motor.

3. The assembly of claim 1, wherein said assembled device will comprise of materials such as skin safe platinum and medical grade silicone.

4. The assembly of claim 1, wherein said floating device comprises of a material that is floatable and formable.

5. The assembly of claim 1 and claim 2, wherein said assembled device will vibrate.

6. The assembly of claim 1, wherein said assembled device can be used as a therapeutic tool for somatic symptoms.

7. The assembly of claim 1, wherein said assembled device can be used as a floatation device, without vibration.

8. The assembly of claim 2, wherein said assembled device will be rechargeable.

9. The assembly of claim 1, wherein said assembled device can be used with outfitted attachments for sexual stimulation.

10. The assembly of claim 1, wherein said assembled device can be used in wet and dry environments.

11. The assembly of claim 1, vibrational motors within a waterproof encasement; incorporated within a positive buoyancy elongated aquatic flotation device.

12. The assembly of claim 2, wherein said assembled vibrational motors will have multiple vibrational points.

13. The assembly of claim 2, wherein said assembled vibrational motors will have multiple layers of impermeability to protect vibrational motors.

14. The assembly of claim 2, wherein said assembled vibrational motors will have the external conventional noodle and foam to provide additional cushion and protection for vibrational motors.

15. The assembly of claim 2, wherein said assembly will have multiple vibrational speeds.

16. The assembly of claim 2, wherein the assembled vibrational motors will be attached to a power switch marked externally to indicate where to press to actuate said switch.
